(19) United States
(12) Patent Application Publication
(10) Pub. No.: US 2025/0210216 A1
(43) Pub. Date: Jun. 26, 2025

(54) Method for generating state-dependent lattices for cold atoms

(71) Applicant: Rheinische Friedrich-Wilhelms-Universität Bonn, Bonn (DE)

(72) Inventor: Martin Weitz, Bonn (DE)

(21) Appl. No.: 18/990,324

(22) Filed: Dec. 20, 2024

(30) Foreign Application Priority Data
Dec. 22, 2023 (DE) 10 2023 136 432.4
Jul. 31, 2024 (DE) 10 2024 121 800.2

(51) Int. Cl. G21K 1/00

(52) U.S. Cl. CPC G21K 1/006

(57) ABSTRACT

A method for generating state-dependent lattice potentials for cold includes irradiating of the atoms with a first bichromatic field including a first light wave and a second light wave running in the opposite direction to the first light wave, wherein the first light wave has a first frequency ω and the second light wave has a second frequency ω+Δω; and irradiating the atoms with a second bichromatic field including a first radio or microwave and a second radio or microwave, wherein the first radio or microwave has a third frequency ω_{MW} and the second radio or microwave has a fourth frequency ω_{MW}−Δω.

The present application is based upon and claims the right of priority to DE Patent Application No. 10 2023 136 432.4, filed on Dec. 22, 2023, and DE Patent Application No. 10 2024 121 800.2, filed on Jul. 31, 2024, the disclosures all of which are hereby incorporated by reference herein in their entireties for all purposes.

The invention relates to a method for generating state-dependent lattice potentials for cold atoms.

Ultracold atoms are currently one of the platforms for the realization of quantum computers and quantum simulators that are being actively investigated both in basic research and commercially. Here, quantum bits, which represent the elementary building blocks of quantum information, are represented in coherent superpositions of internal states of individual atoms. Coherent manipulation of the cold atoms by means of laser radiation is now essential for operation, which is also used to achieve targeted coupling of the individual quantum bits. This makes it possible to perform quantum calculations or quantum simulations. A central element for some quantum calculation and simulation methods are state-dependent optical lattices, in which the light potential achieved by laser manipulation depends on the internal state of the atoms. This makes it possible, for example, to entangle ultracold atoms in the lattice by controlled collisions and to realize quantum gates. In particular, state-dependent lattice potentials allow the inherent periodicity of the lattices to be used to perform many quantum logic operations in parallel, which can enable the entanglement of a large number of atoms in a single step. This can provide the redundancy required for quantum error correction or the highly entangled resource states required for measurement-based quantum information methods.

In conventional methods for state-dependent manipulation in the atomic lattice, standing waves of different polarization are used. For the alkali atoms most commonly used—which have an S ground state corresponding to a total electronic orbital angular momentum of L=0—the detuning of the laser beams from the atomic resonance must not be higher than the fine structure splitting of the excited state in this method. Due to the necessary use of comparatively near-resonant light beams, this leads to a limitation of the decoherence time and thus the number of possible calculation operations.

Other conventional known methods for state-dependent lattice manipulation store the quantum bits using excited atomic states, which also entails intrinsic limitations in the number of possible operations due to possible decoherence processes.

The devices or methods known from the state of the art do not yet allow the state selection of the light potentials to be generated independently of the optical transitions.

Based on this, the objective technical problem of the invention is to generate low-decoherence state-dependent lattice potentials, in particular by selective manipulation.

This problem is solved by the object of claim 1. Preferred further embodiments can be found in the sub-claims.

According to the invention, a method for generating state-dependent lattice potentials for cold atoms is thus provided, with the following method steps:
Irradiating the atoms with a first bichromatic field including a first light wave and a second light wave running in the opposite direction to the first light wave, wherein
the first light wave has a first frequency ω and
the second light wave has a second frequency ω+Δω; and
irradiating the atoms with a second bichromatic field including a first radio or microwave and a second radio or microwave, wherein
the first radio or microwave has a third frequency ω_{MW} and
the second radio or microwave has a fourth frequency ω_{MW}-Δω

The basic idea here is that with this method the spatial periodicity of the lattice potentials is made possible by a first bichromatic field including two light waves traveling in opposite directions, while the state dependence of these potentials is achieved by a second bichromatic field including two radio or microwave fields.

In the present case, “light waves running in opposite directions” refers in particular to light waves that do not run parallel to each other. These do not necessarily have to be antiparallel but are preferably arranged at an angle not equal to 0° to each other, particularly preferably at an angle between 160° and 200°, with 180° corresponding to an antiparallel arrangement.

Preferably, it is provided that the frequency of the first and/or second radio waves or microwaves is 10⁵ times smaller than the frequency of the first and/or second optical light wave.

“Cold atoms” are atoms that have been cooled to extremely low temperatures, typically close to absolute zero (0 Kelvin or −273.15 degrees Celsius). In physics, cold atoms play an important role in the study of quantum effects that are difficult to observe at higher temperatures. One of the main methods for generating cold atoms is laser cooling, in which atoms are slowed down and cooled by targeted interactions with laser light. Photons from the laser light transfer their momentum to the atoms, reducing their kinetic energy and thus their temperature. A common technique for generating and maintaining cold atoms is the magneto-optical trap (MOT). Here, magnetic fields and laser beams are used to trap the atoms in a small area of space and cool them down further.

At even lower temperatures, close to absolute zero, as achieved in particular by evaporative cooling of atoms that are initially pre-cooled by laser cooling, atoms that have an integer total angular momentum (so-called bosons) can join together in a state known as a Bose-Einstein condensate (BEC). In this state, the atoms behave like a single quantum object and macroscopic quantum effects can be observed.

Cold atoms are an important tool in quantum optics and quantum information research. They enable the realization of quantum computers, quantum communication systems and high-precision measuring instruments such as atomic clocks. In addition, cold atoms provide a platform for investigating fundamental physical phenomena such as the interactions between atoms, the formation of superfluidity and superconductivity and the simulation of complex quantum mechanical systems.

It is thus a decisive point of the invention to realize a light potential with a state selection made possible by radio frequency (or microwave) fields. Such a light potential is achieved by irradiating the atoms with both two opposing light beams of slightly different frequencies and a bichromatic radio or microwave frequency field. This drives virtual Doppler-sensitive multiphoton transitions whose resonance condition is only given for a single atomic state, since only for this state is another long-lived atomic auxiliary state, which serves as an intermediate state, close enough in energy. Atoms in the desired eigenstate can now be selectively manipulated with a suitable choice of parameters by specifically varying the phase of one of the two driving laser beams.

It is essential that the method is not limited to the use of laser tunings of the order of magnitude of the fine structure, for example 15 nm for the case of the rubidium atom, since the state selection is not achieved by the optical transitions, but by radio frequency (or microwave) transitions. However, the momentum transfer of the optical photons still allows the cold atoms to be trapped in the lattice potential. Lattice beams (which refers to a corresponding choice of the first and second frequencies) can be used at any detuning, for example 270 nm when using a neodymium laser with a wavelength of 1.06 μm, or even around 1300 nm when using laser radiation with a wavelength close to 2 μm, so that virtually no heating methods due to the scattering of spontaneous photons are to be expected. State-dependent lattice manipulation allows atoms to be entangled in the lattice and quantum gates to be realized, for example through controlled cold collisions, whereby very long coherence times are made possible. This is the prerequisite for a high number of quantum logic calculations and powerful quantum simulations.

In particular, the second frequency of the second light wave including the frequency ω+Δω/N, where N is a natural number (N∈ [symbol] ). In order to generate a desired state-selective lattice potential, a bichromatic light field with two light waves traveling in opposite directions and a bichromatic radio or microwave field are irradiated, resulting in a state-selective multiphoton lattice potential of the spatial period λ/2N. In particular, a four-photon lattice of period λ/2 with two radio frequency or microwave photons and two optical photons results for N=1, and a six-photon lattice of period λ/4 with two radio frequency or microwave photons and four optical photons results for N=2. The scheme can be continued for further multiphoton lattices with N=3, N=4, etc.

Preferably, the third and/or fourth frequency is selected in the vicinity of a radio frequency (or microwave) transition from one atomic state to another atomic auxiliary state, which serves as an intermediate state, in order to enable state selection. The auxiliary state is particularly long-lived, which can be realized if both the state for which the lattice potential is generated and the auxiliary state are components of the Zeeman or hyperfine manifold of the electronic ground state (the 5 s_{1/2} ground state for the case of the rubidium atom). “Long-lived” here means in particular that the lifetime of the auxiliary state, which enables state selection, is preferably more than 106 times longer than that of the relevant excited atomic state, particularly preferably more than 10 times longer. To ensure that the atomic population remains as completely as possible in the state for which the lattice potential is generated and that there is little non-resonant excitation into the auxiliary state, the detuning of the third and/or fourth frequency from the auxiliary state is preferably at least three times the Rabi frequency of the radio and/or microwave fields and the Raman coupling caused by the first bichromatic field, particularly preferably five times. The third and fourth frequencies preferably differ from each other by at least this amount. For N>1, it is particularly intended that the frequency of the radio and/or microwave fields are either both greater or both less than the transition frequency from the state for which the lattice potential is generated to the auxiliary state. This means that even in the higher-order multiphoton methods described, non-resonant excitation into the auxiliary state can be minimized by coupling terms other than the desired ones.

According to a preferred further development of the invention, the difference between the third frequency ω_{MW} and the fourth frequency ω_{MW}-Δω is at Least a Factor of Five Smaller than the difference between two Zeeman levels of the atoms, particularly preferably a factor of ten. This means in particular that the corresponding difference frequencies of the bichromatic fields are correspondingly smaller than the energetic splitting between different Zeeman levels given by an applied magnetic field, which is advantageous for the desired state selectivity.

According to a preferred further development of the invention, the difference between the first and second frequency of the light waves is much smaller, in particular a 10⁵-times smaller than the difference between the third and fourth frequencies of the radio waves or microwaves.

According to a preferred further development of the invention, the difference between the wavelength of the first light wave and the wavelength of the second light wave is very small, in particular of the order of magnitude 10⁻¹⁰ m. As a result, Δω<<ω, because the wavelengths are very close to each other. The wavelengths of the light waves with the first frequency ω and the second frequency ω+Δω are in particular

$$λ = 2 π c / ω und$$

$${λ}^{′} = 2 π c / ( ω + Δ ω / N ) .$$

As λ is typically very close to λ′ and the frequency of the radio or microwave fields is preferably much lower than the optical frequencies, the lattice potential for N=1 has, to a very good approximation, a spatial period of half the optical wavelength (λ/2), which corresponds to the value of a standing wave lattice generated by two counter-propagating frequencies of the same wavelength. For N=2, a very good approximation results in a spatial period of a quarter of the optical wavelength (λ/4).

According to a preferred further development of the invention, the method includes the following further method step:
Shifting the phase position of the second frequency ω+Δω to spatially shift the lattice potentials.

In particular, the second frequency includes the frequency ω+Δω/N, where N is a natural number (N∈ [symbol] ). The lattice can be spatially shifted, for example, by varying the phase position of the optical frequency ω+Δω/N, which changes the phase angle of the Rabi frequency Ω′. The corresponding shift causes a state-dependent lattice manipulation, as the generated potential depends on the internal state of the atoms.

According to a preferred further development of the invention, the method includes the following further method steps:
Irradiating the atoms with a third bichromatic field including a third light wave and a fourth light wave running in the opposite direction to the third light wave, wherein
the third light wave has a fifth frequency ω′ and
the fourth light wave has a sixth frequency ω′+Δω′ irradiating the atoms with a fourth bichromatic field including a third and a fourth radio or microwave, wherein
the third radio or microwave has a seventh frequency ω′_{MW} and
the fourth radio or microwave has an eighth frequency ω′_{MW}-Δω′.

In particular, the sixth frequency of the fourth light wave includes the frequency ω+Δω/N, where N is a natural number (N∈ [symbol] ). In particular, a four-photon lattice of period λ/2 with two radio frequency or microwave photons and two optical photons results for N=1, and a six-photon lattice of period λ/4 with two radio frequency or microwave photons and four optical photons results for N=2. The scheme can be continued for further multiphoton lattices with N=3, N=4, etc.

By irradiating further light and radio or microwave frequency fields, the atomic population in a second state can be spatially manipulated, in particular by adapting the resonance condition. This makes it possible to realize state-dependent quantum manipulations in the lattice also for coherent superpositions of two states with the method—i.e. for quantum bits. The lattice potentials effective for the individual atomic states can be spatially shifted independently of each other by varying the phase position of the light beams that generate them, which in particular enables atoms in the lattice to be entangled by controlled cold collisions and quantum logic operations.

According to the invention, the use of the method according to one of the preceding claims for generating state-dependent lattices for cold atoms is further provided.

In the following, the invention is explained in further detail with reference to the drawings by means of a preferred embodiment of the invention.

The drawings show

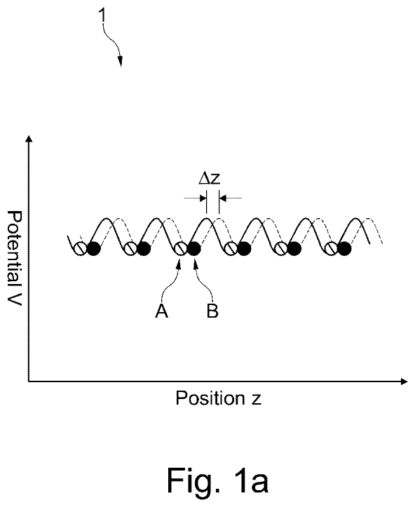

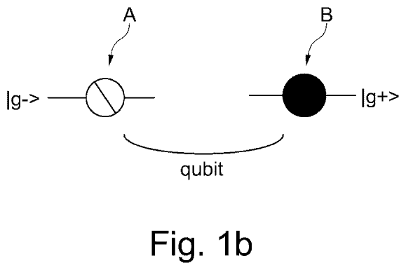

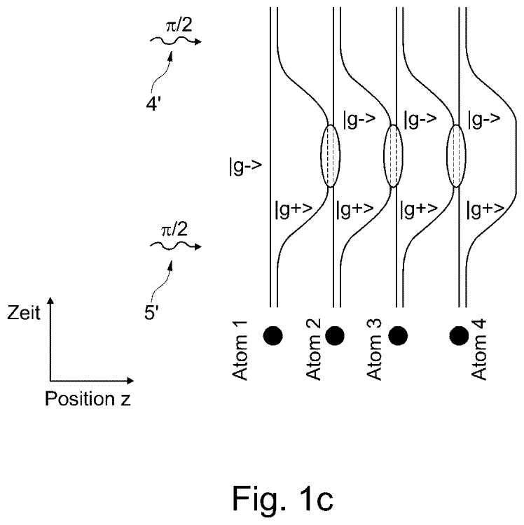

FIG. 1a, 1b, 1c schematically a state-dependent lattice potential generated by a method according to a preferred embodiment of the invention, and as an exemplary application the scheme of an entanglement operation,

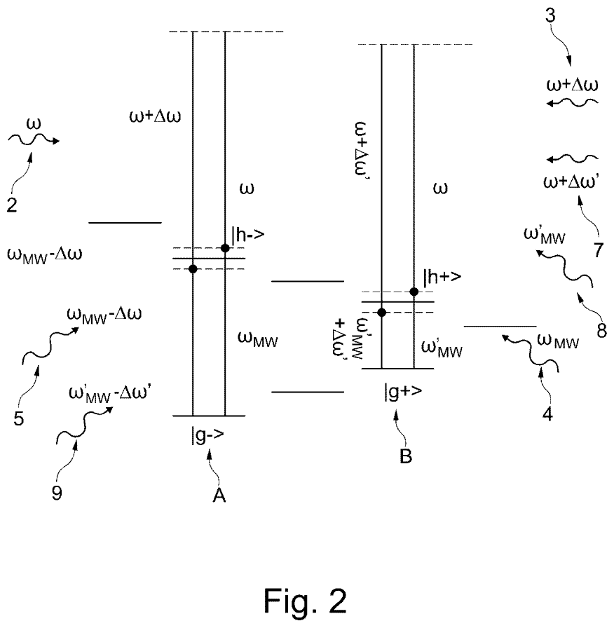

FIG. 2 schematically the relevant transitions of a rubidium atom,

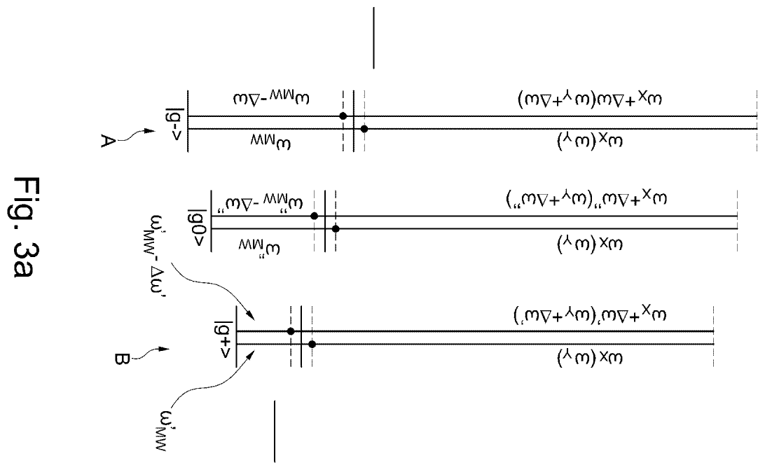

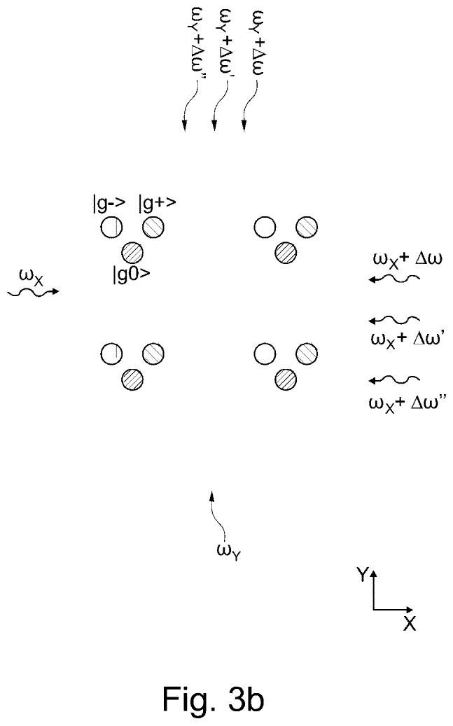

FIG. 3a, 3b schematically a coupling diagram and the position of the potential maxima of the lattice potential for a further embodiment of the invention,

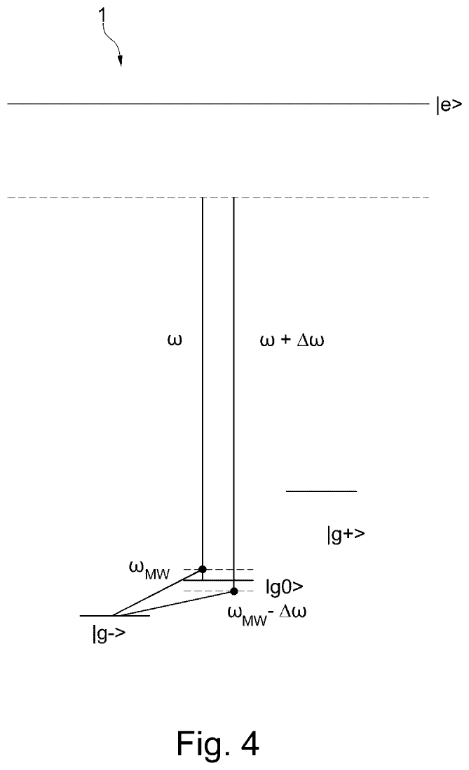

FIG. 4 schematically a coupling diagram for a further embodiment of the invention.

FIG. 1a schematically shows a state-dependent lattice potential generated with the method for atoms in the quantum states |g->A and |g+>B. The lattice potential relevant for atoms in the two states is spatially shifted by the length Δz relative to each other. As shown schematically in FIG. 1b for the case N=1, quantum bits can be stored in a superposition of these two states. The generation of such state-dependent lattice potentials is also possible with the method using light that is extremely far detuned from the atomic resonances, which allows long coherence times. FIG. 1c shows an example of how the method can be used to entangle four atoms initially located in |g-> in a one-dimensional lattice with a state-dependent lattice operation. For this purpose, a coherent superposition of the quantum states |g-> and |g+> is generated in each of the atoms in a first π/2 pulse 4′, as a result of the subsequent state-dependent shift operation an atomic phase shift occurs in the dashed areas due to cold elastic interatomic collisions, and at the end a further π/2 pulse 5′ is emitted. The π/2 pulses can, for example, be driven with two radio frequency fields whose difference frequency corresponds to the energetic distance between the states |g+> and |g->.

FIG. 2 shows a diagram of the ground state levels of the rubidium atom (isotope⁸⁷ Rb) as well as relevant transitions. In this embodiment example with N=1, a lattice potential for atoms in one of the Zeeman states of the lower hyperfine ground state F=1, 5 s_{1/2} of this atom is specifically to be achieved, whereby levels of the upper hyperfine ground state F=2, 5 s_{1/2} that can be achieved with a microwave transition near 6.8 GHz serve as auxiliary states (for precise state selection). Furthermore, optical photons can be used to drive transitions to the low electronically excited states 5p_{1/2} and 5p_{1/2} (not shown in the figure). In order to achieve a very small spontaneous scattering rate and thus a correspondingly small decoherence rate, light fields are used here whose detuning from the optical transitions is very large, in particular here much larger than the fine structure splitting of 15 nm between the levels 5p_{1/2} and 5p_{1/2} (the resonance wavelength of the transitions 5 s_{1/2}−5p_{1/2} and 5 s_{1/2}−5p_{1/2} is 795 nm and 780 nm respectively). In such a light field, no Raman transitions can be driven between different Zeeman or hyperfine components, moreover, the vectorial and tensorial atomic polarizability disappears and only the scalar part of the polarizability remains; the behavior of ground state atoms for optical light fields essentially corresponds to that of an L=0→L′=1 transition.

In order to achieve the desired state-selective lattice potential, a bichromatic light field with two light waves traveling in opposite directions and a bichromatic field, which in this embodiment example is in the microwave range, are irradiated, which in this embodiment example with N=1 leads to a state-selective four-photon lattice potential of the spatial period λ/λ, where λ, denotes the wavelength of the optical lattice light beams. Specifically, a lattice potential for the ground state level m=−1, F=1 (short: 1 g->) A is achieved here by driving virtual four-photon transitions by irradiating a light beam 2 of the optical frequency ω and an opposing field 3 of the frequency Δω+ω (with Δω<<ω, wavelength in both cases in good approximation λ), as well as two microwave fields 4, 5 of the frequencies ω_{mw} and ω_{mw}−Δω. The frequencies of the microwave fields 4, 5 are detuned from the resonant frequency ω_{HFS,-1} of the transition to the ground state level F=2, m=1 (short: lh->), which serves as an auxiliary state, in order to suppress resonant transitions, but smaller than the energetic splitting between different Zeeman levels, which is given by an applied magnetic field in order to enable state selectivity. A calculation gives approximately the following expression for the lattice potential for atoms in the state lg->A, where z denotes the axis of the optical lattice light beams:

$${V}_{g - , 4} = \frac{ℏ}{16 {Δδδ}^{′}} ( {Ω}_{m w} {Ω}_{mw}^{′ ⋆} Ω {Ω}^{′ ⋆} {e}^{2 ikz} + c . c . ) ,$$

$$where$$

$$k = 2 π / λ , = {δω}_{m w} - {ω}_{HFS , - 1}$$

$$and$$

$${δ}^{′} = {ω}_{H F S , - 1} - {ω}_{m w} + Δω .$$

Furthermore, Ω and Ω′ denote the Rabi frequencies of the optical transitions driven by the light beams of the frequencies ω and ω+Δω and Ω_{mw} and Ω_{mw}′ denote the transitions between the hyperfine levels driven by the microwave fields 4, 5 (specifically between the states le> and lh-> as well as lh-> and lg->, where le> denotes the electronically excited state). It was assumed here that |λ|> |Ω_{mw}|, |Ω_{mw} ′|, |ΩΩ′*/2Δ| and |λ′|>>|Ω_{mw}|, |Ω_{mw}′, |ΩΩ′*/2Δ| and that Δω is greater than the inverse of the time scale relevant for the dynamics of the external degrees of freedom. Typical realistic experimental parameters are |Ω_{mw}/2π|, |Ω_{mw} ′/2π|, |ΩΩ′*/2Δ|≈100 kHz, as well as δ/2π, δ′/2π≈300 kHz, which results in a lattice potential of about the depth h·10 kHz, corresponding to about 3 photon recoil energies of the rubidium atom. The lattice potential has a spatial period of half the optical wavelength (λ/2), which corresponds to the value of conventional standing wave lattices, which are generated by two opposing frequencies of the same wave. The lattice can be spatially shifted, for example, by varying the phase position of the optical frequency Δω+ω, which changes the phase angle of the Rabi frequency Ω′.

For atoms in a further component of the hyperfine ground state, independently manipulated lattice potentials can now be generated in the same way by irradiating further light fields. This is shown in FIG. 2 for the ground state m_{F}=1, F=1 (short: lg₊>) B. For this purpose, a light field 7 of the frequency ω′+Δω′ (in this case ω′=ω and the light field of the frequency ω, which is radiated in the opposite direction, can be “used” here), as well as radio frequency fields 8, 9 of the frequencies ω_{mw}′ and ω_{mw}′−Δω′. The phase position of this lattice potential can be controlled analogously, for example by varying the phase of the light beam of the frequency ω_{mw}′−Δω′, which enables independent control of the lattice potential relevant for the atomic occupation in the different states. Likewise, components of atomic wave functions in different states can be manipulated accordingly, which enables state-dependent lattice manipulation, which enables entanglement by means of, for example, controlled cold interatomic collisions or quantum logic operations with cold atoms.

In particular, more than two states (for example here also the state m=0, F=1 (in short lg₀>) can be shifted in their position independently of each other by irradiation of corresponding further light and radio frequency fields, also in more than one dimension, whereby here too the state selection is formed analogously by two microwave fields and the momentum transfer relevant for the spatial potential in Fourier space is formed by the difference of the wave vectors of the two light fields closing the virtual four-photon transition. FIG. 3a shows the coupling scheme and FIG. 3b shows an example of the position of the potential minima of such a design for a two-dimensional lattice potential. The trap potential effective along the x- (y-) direction is formed here for the state lg.> by a light wave of the frequency ox (ω_{y}) radiated along the corresponding axis, an opposing light wave of the frequency ωₓ+Δω (ω_{y}+Δω) as well as a first radio or microwave of the frequency ω_{MW} and a second radio or microwave of the frequency ω_{MW}-Δω are realized. Trap potentials for the |g-> state can be similarly realized by light waves of the frequency ωₓ(ω_{y}) emitted along the corresponding axes, light waves of the frequency ωₓ+Δω′ (ω_{y}+Δω′) and a first and a second radio or microwave of the frequencies ω_{MW}′ and ω_{MW}′−Δω′, for the state lg₀> realized by light waves of frequency ωₓ (ω_{y}), light waves of frequency ωₓ+Δω″ (ω_{y}+Δω″) and radio or microwave waves of frequencies ω_{MW}″ and ω_{MW}″−Δω ″.

In some applications, it may also in particular be desirable to not have the state-dependent lattice potential active for all lattice sites simultaneously. To achieve this, a focused laser beam, far detuned from atomic transitions, can be directed through an optical quantum gas microscope to locally address specific lattice sites and at these sites via the induced dynamical Stark effect shift atomic transitions far out of resonance, depending on the beam's polarization and optical frequency, for all or predominantly some internal states.

As a result, the four-photon lattice potential can be selectively deactivated at specific regions of the lattice.

FIG. 4 shows the coupling scheme for an embodiment in which a state-dependent lattice potential (in addition to optical lattice light beams) is only generated by radio frequency fields tuned by close transitions within a Zeeman manifold. In this case, such a high static magnetic field is applied that the Zeeman splitting between neighboring Zeeman levels is noticeably different, the Paschen-Back region is at least approached and transitions between neighboring Zeeman levels can be addressed individually (for ultracold rubidium atoms for typical experimental parameters from about 30 Gauss). A lattice potential for atoms in the lg. > state can now be generated using the method by tuning the radio frequency fields 4, 5 (the frequencies ω_{mw} and ω_{mw}−Δω are selected accordingly) close to the transition to the lg₀> state and generating an independently controllable lattice potential and an independently controllable lattice potential for atoms in the state lg+>B by selecting the frequencies ω_{mw}′ and ω_{mw}′−Δω ′ near the transition between the states lg₀> and lg+>B. In this regime of a high enough magnetic field such that the level splitting between neighboring Zeeman levels is not the same for all magnetic sublevels state-dependent lattice potentials can also be generated for e.g. the first order field insensitive components in the different hyperfine states of the electronic ground state manifold m_{F}=0, F=1 and m_{F}=0, F=2 respectively. The use of these states, which are commonly used also in atomic clocks, offer advantages in terms of a reduced sensitivity of the qubit transition frequency to stray magnetic fields, which is helpful to minimize the decoherence rate.

### LIST OF REFERENCE SYMBOLS

1 State-dependent lattice potential
2 first light wave with first frequency ω
3 Second light wave with second frequency ω+Δω
4 first radio or microwave with third frequency ω_{MW}
4′ first radio wave with π/2 pulse
Second radio or microwave with fourth frequency ω_{MW}-Δω
5′ second radio wave with π/2 pulse
6 Third light wave with fifth frequency ω′
7 fourth light wave with sixth frequency ω′+Δω′
8 Third radio or microwave with seventh frequency ω′_{MW}
9 fourth radio or microwave with eighth frequency ω_{MW}-Δω
A Atoms in the quantum states |g->
B Atoms in the quantum states lg+>

1. A method for generating state-dependent lattice potentials for cold atoms, the method comprising:
irradiating of the atoms with a first bichromatic field comprising a first light wave and a second light wave running in the opposite direction to the first light wave, wherein:
the first light wave includes a first frequency ω and
the second light wave includes a second frequency ω+Δω; and
irradiating the atoms with a second bichromatic field comprising a first radio or microwave and a second radio or microwave, wherein:
the first radio or microwave (4) includes a third frequency ω_{MW} and
the second radio or microwave (5) includes a fourth frequency ω_{MW}−Δω

2. The method according to claim 1, wherein the difference of the first frequency ω and the second frequency ω+Δω and/or the difference of the third frequency ω_{MW} and the fourth frequency ω_{MW}−Δω is smaller than the difference between two Zeeman levels of the atoms.

3. The method according to claim 1, wherein the difference between the first frequency ω and the second frequency ω+Δω is much smaller, in particular a factor of 10⁵-times smaller than the difference of the third frequency ω_{MW} and the Fourth Frequency ω_{MW}−Δω

4. The method according to claim 1, wherein the difference between the wavelength of the first light wave and the wavelength of the second light wave in the order of magnitude 10⁻¹⁰ m.

5. The method according to claim 1, further comprising:
shifting the phase position of the second frequency ω+Δω to spatially shift the lattice potentials.

6. The method according to claim 1, further comprising:
irradiating of the atoms with a third bichromatic field comprising a third light wave and a fourth light wave running in the opposite direction to the third light wave, wherein:
the third light wave includes a fifth frequency ω′ and
the fourth light wave includes a sixth frequency ω′+Δω′,
irradiating the atoms with a fourth bichromatic field comprising a third radio or microwave and a fourth radio or microwave, wherein:
the third radio or microwave includes a seventh frequency ω′_{MW} and
the fourth radio or microwave includes an eighth frequency ω′_{MW}−Δω′.
